(19) United States
(12) Patent Application Publication
(10) Pub. No.: US 2026/0017077 A1
(43) Pub. Date: Jan. 15, 2026

(54) METHOD AND APPARATUS FOR DETERMINING OPERATING FREQUENCY OF VIRTUAL MACHINE, ELECTRONIC DEVICE AND STORAGE MEDIUM

(71) Applicant: Beijing Baidu Netcom Science Technology Co., Ltd., Beijing (CN)

(72) Inventors: Rongqing LI, Beijing (CN); Shiyuan GAO, Beijing (CN); Fushuai WANG, Beijing (CN); Ru YING, Beijing (CN); Kezhan MIAO, Beijing (CN); Ran ZHENG, Beijing (CN); Xianjun MENG, Beijing (CN)

(21) Appl. No.: 19/330,722

(22) Filed: Sep. 16, 2025

(30) Foreign Application Priority Data
Apr. 23, 2025 (CN) 202510515281.2

(51) Int. Cl. G06F 9/455; G06F 9/30

(52) U.S. Cl. CPC G06F 9/45533; G06F 9/3013

(57) ABSTRACT

A method and an apparatus for determining an operating frequency of a virtual machine, an electronic device, and a storage medium are provided. The method includes: obtaining a target register from a pass-through list, and acquiring register data corresponding to the target register, where registers in the pass-through list is accessible by the virtual machine; during the operation of the virtual machine, in response to receiving an instruction to read the target register data, passing through the register data corresponding to the target register to the virtual machine, so that the virtual machine obtains the operating frequency of the virtual machine according to the register data.

### CROSS-REFERENCE TO RELATED APPLICATIONS

This application claims the priority from Chinese Patent Application No. 202510515281.2, filed on Apr. 23, 2025, the entire disclosure of which is hereby incorporated by reference.

### TECHNICAL FIELD

The present disclosure relates to the field of computer technologies, in particular, to the field of virtualization technologies in cloud scenarios, and more particularly, to a method for determining an operating frequency of a virtual machine, an electronic device, and a storage medium.

### BACKGROUND

In the current virtualization environment based on QEMU (Quick Emulator, virtualization management software) and KVM (Kernel-based Virtual Machine, kernel virtualization module), the operating frequency of a virtual machine is usually a fixed value, and this value is generally consistent with the nominal main frequency of the host CPU (Central Processing Unit). However, modern CPUs support dynamic frequency adjustment technology, which means the actual operating frequency of the host CPU may change dynamically due to factors such as load, temperature, or power consumption. In addition, when the host CPU frequency decreases due to abnormal conditions (such as overheating or power management policies), the actual operating frequency of the virtual machine will also fluctuate accordingly. Nevertheless, in existing technologies, the displayed operating frequency of the virtual machine is usually a fixed value, and users cannot perceive changes in the actual operating frequency of the virtual machine, which limits the real-time monitoring and optimization of the performance of the virtual machine by the user.

### SUMMARY

The present disclosure provides a method for determining an operating frequency of a virtual machine, an electronic device, and a storage medium.

According to an aspect of the present disclosure, there is provided a method of determining an operating frequency of a virtual machine, the method including:
acquiring a target register from a pass-through list, and acquiring register data corresponding to the target register, where registers in the pass-through list are accessible by the virtual machine; and
passing through register data corresponding to the target register to the virtual machine during operation of the virtual machine, in response to receiving a read target register data instruction, so that the virtual machine obtains the operating frequency of the virtual machine according to the register data.

According to a second aspect of the present disclosure, there is provided an electronic device including:
at least one processor; and
a memory in communication with the at least one processor; where the memory stores instructions executable by the at least one processor to enable the at least one processor to perform the method of any of the above-described solutions.

According to a third aspect of the present disclosure, there is provided a non-transitory computer-readable storage medium storing computer instructions, where the computer instructions are used to cause the computer to perform the method according to any one of the above technical solutions.

It should be understood that the content described in this section is not intended to identify key or essential features of the embodiments of the present disclosure, nor is it intended to limit the scope of the present disclosure. Other features of the present disclosure will become readily understood through the following description.

### BRIEF DESCRIPTION OF THE DRAWINGS

The accompanying drawings are used for better understanding of the solution and do not constitute a limitation to the present disclosure.

FIG. 1 is a schematic diagram of steps of a method for determining an operating frequency of a virtual machine according to an embodiment of the present disclosure;

FIG. 2 is a schematic diagram of a flow of a pass-through mechanism according to an embodiment of the present disclosure;

FIG. 3 is a schematic diagram of a pass-through mechanism according to an embodiment of the present disclosure;

FIG. 4 is a diagram of a process of reading and writing register data according to an embodiment of the present disclosure;

FIG. 5 is a schematic diagram of a flow of a compensation mechanism according to an embodiment of the present disclosure;

FIG. 6 is a schematic block diagram of an apparatus for determining an operating frequency of a virtual machine according to an embodiment of the present disclosure;

FIG. 7 is a block diagram of an electronic device used to implement a method of determining an operating frequency of a virtual machine according to an embodiment of the present disclosure.

### DETAILED DESCRIPTION

The following describes exemplary embodiments of the present disclosure with reference to the accompanying drawings, which include various details of the embodiments of the present disclosure to facilitate understanding and should be regarded as merely exemplary. Therefore, those of ordinary skill in the art should recognize that various changes and modifications can be made to the embodiments described herein without departing from the scope and spirit of the present disclosure. Similarly, for clarity and conciseness, descriptions of well-known functions and structures are omitted in the following description.

The following describes exemplary embodiments of the present disclosure with reference to the accompanying drawings, which include various details of the embodiments of the present disclosure to facilitate understanding and should be regarded as merely exemplary. Therefore, those of ordinary skill in the art should recognize that various changes and modifications may be made to the embodiments described herein without departing from the scope and spirit of the present disclosure. Similarly, for clarity and conciseness, descriptions of well-known functions and structures are omitted in the following description.

In the current virtualization environment, the methods for checking the operating frequency of a virtual machine mainly include the following types.

The first method is to check through the interfaces exposed by the virtual machine. A virtual machine usually reports CPU (Central Processing Unit) frequency information via operating system interfaces (such as/proc/cpuinfo) or system tools (such as cpupower monitor, turbostat, etc.). These tools rely on accessing the values of APERF (Actual Performance Frequency, actual performance frequency register) and MPERF (Maximum Performance Frequency, maximum performance frequency register) to determine the actual operating frequency of the CPU. However, in the virtualization scenario based on QEMU (Quick Emulator, virtualization management software) and KVM (Kernel-based Virtual Machine, kernel virtualization module), the virtual machine cannot directly access these registers. As a result, the tools can only return the fixed main frequency value of the CPU and cannot reflect the actual dynamic frequency changes of the CPU.

The second method is to observe using tools on the virtual machine, that is, the operating frequency of the CPU may be calculated indirectly by using performance analysis tools (such as perf) or writing custom test programs in the virtual machine. This method typically obtains the number of CPU cycles within a certain period by accessing the Performance Monitoring Unit (PMU), and calculates the CPU operating frequency in combination with the task-clock (i.e., the time when the CPU actually executes tasks). Although this method does not rely on the APERF/MPERF registers, it has some drawbacks: it is relatively complex to use and not intuitive enough; the results may be inaccurate-due to the scheduler or other system interferences (such as context switching, interrupt handling, etc.), the calculation results of the performance analysis tool may have deviations and cannot provide accurate frequency information.

The third method is to check through the host machine. Since the operating frequency of the CPU in the virtual machine is usually consistent with that of the host machine, the CPU frequency of the virtual machine may be indirectly estimated by checking the CPU frequency of the host machine. However, in a virtualized cloud environment, users can usually only log in to and manage the virtual machines they own, and cannot obtain access rights to the host machine. This permission restriction prevents users from indirectly obtaining the CPU frequency information of the virtual machine through the host machine, further exacerbating the difficulty of frequency monitoring in the virtualization environment.

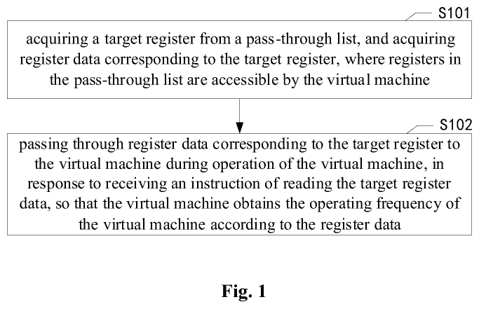

To address the above technical issues, the present disclosure provides a method for determining the operating frequency of the virtual machine. Refer to FIG. 1, which is a schematic diagram of the steps of the method for determining the operating frequency of a virtual machine in an embodiment of the present disclosure. This method is applied to KVM and includes the following steps.

Step 101 includes: acquiring the target register from the pass-through list, and acquiring the register data corresponding to the target register. The register in the pass-through list is accessible by the virtual machine.

Specifically, the “target register” refers to a specific hardware register related to virtual machine performance monitoring, such as MSR_IA32_APERF and MSR_IA32_MPERF. These registers record the frequency of the CPU in the actual operating state and the frequency in the maximum performance state, respectively. The pass-through list is a list maintained by a virtualization kernel module (such as KVM), which is used to record which hardware register values should be directly passed through to the virtual machine instead of being accessible indirectly through the virtualization layer. When the virtual machine is running, the virtual machine obtains the target registers from the pass-through list, acquires the register data corresponding to the target registers, and directly transmits these values to the virtual machine. In this way, the in virtual machine can directly access the data of these registers, thereby obtaining the actual operating frequency of the CPU in real time for performance monitoring and optimization. This mechanism not only improves the accuracy and real-time performance of performance monitoring but also reduces the overhead of the virtualization layer, enabling the virtual machine to more efficiently utilize the performance monitoring features of the host CPU.

Step S102 includes: passing through register data corresponding to the target register to the virtual machine during operation of the virtual machine, in response to receiving an instruction of reading the target register data, so that the virtual machine obtains the operating frequency of the virtual machine according to the register data.

Taking target registers including APERF (Actual Performance Frequency, actual performance frequency register) and MPERF (Maximum Performance Frequency, maximum performance frequency register) as an example, APERF and MPERF are used to measure the actual operating frequency of the CPU in actual operation and the number of operating cycles at maximum frequency. Specifically, the APERF counter records the number of cycles of the CPU in the actual operating state, which reflects the actual operating frequency of the CPU under the current load and frequency adjustment strategy. The MPERF counter records the number of cycles of the CPU at maximum frequency (i.e., nominal main frequency), which represents the number of operating cycles of the CPU in an ideal state. Therefore, the current operating frequency of the CPU may be obtained through calculations using these two counters.

The specific calculation process is as follows: first, the kernel detects whether the CPU supports the X86_FEATURE_APERFMPERF feature (also referred to as the target feature). If supported, the kernel reads the current values of the APERF and MPERF counters during each clock interrupt, calculates the differences from the previous sampled values (ΔAPERF and ΔMPERF), and saves them. When the user executes cat/proc/cpuinfo, the kernel calculates the operating frequency of the virtual machine using the following formula based on these differences, and the specific formula is:

$$the actual operating frequency of CPU = Δ APERF / Δ MPERF * CPU\_KHZ ,$$

where ΔAPERF and ΔMPERF are differences from the previous sample values, and CPU_KHZ is the nominal frequency of the CPU.

The present disclosure provides a method and apparatus for determining the operating frequency of the virtual machine, an electronic device, and a storage medium. In the present disclosure, by adding a target register to the pass-through list and passing the register data of the target registers through to the virtual machine during the operation of the virtual machine, the virtual machine can calculate and obtain its own operating frequency in real time based on the register data. This pass-through mechanism enables the virtual machine to directly access the values of the target registers, thereby obtaining the actual operating frequency of the host machine in real time. Furthermore, it solves the problem in traditional virtualization environments where the virtual machine can only see a fixed frequency, allowing the virtual machine to dynamically perceive frequency changes in the host machine. Secondly, in response to an instruction to read the target register data, the present disclosure directly reads the passed-through register data, thereby accurately calculating the operating frequency of the virtual machine. This method of directly accessing hardware registers avoids the problem of inaccurate frequency perception caused by the abstraction of the virtualization layer in traditional methods. It can be seen from this that the pass-through mechanism of the present solution enables the virtual machine to perceive the actual operating frequency of the host machine in real time, thereby significantly improving the real-time performance and accuracy of the virtual machine in terms of performance monitoring and optimization. This not only enhances the performance of the virtual machine but also provides more accurate performance feedback for applications in the virtualization environment, which helps to achieve more efficient and flexible resource management and performance optimization.

In some optional embodiments, prior to obtaining the target register from the pass-through list, the method further includes the following.

In response to determining that a request instruction for enabling a target feature is received, the target register information included in the request instruction for enabling the target feature is added to the pass-through list.

Specifically, the “request instruction for enabling the target feature” refers to an instruction sent by virtualization management software (such as QEMU) to a kernel virtualization module (such as KVM) for enabling specific hardware features, such as CPU performance monitoring registers (such as APERF and MPERF). These instructions include “target register information”, i.e., the identification information of specific hardware registers that need to be enabled. When KVM receives such a request, the KVM adds the register information to the “pass-through list”-a list maintained by KVM that records which hardware register values should be directly passed through to the virtual machine, enabling the virtual machine to directly access the values of these registers without indirect access through the virtualization layer.

The implementation process of this solution includes the following: QEMU sends a request to enable the target feature to KVM through an ioctl (device control) system call. This request includes the identification information of the target register, such as the register numbers of MSR_IA32_MPERF and MSR_IA32_APERF. After receiving the request, KVM parses the target register information in the request and adds the identifiers of these registers to the pass-through list. Once the register information is added to the pass-through list, KVM ensures that the virtual machine can directly access the values of these registers. When the virtual machine executes an instruction to read these registers, KVM reads the register values directly from the hardware and returns them to the virtual machine, instead of returning a fixed value or an emulated value.

In this way, by adding the target register information to the pass-through list upon receiving the request instruction for enabling a target feature, the virtual machine can directly access the data of these registers. This mechanism not only improves the virtual machine ability to perceive the host CPU features but also enhances the accuracy and real-time performance of performance monitoring. Specifically, the virtual machine can calculate its own operating frequency in real time based on the register data, thereby monitoring and optimizing performance more accurately. This method of directly accessing hardware registers avoids the problem of inaccurate frequency perception caused by the abstraction of the virtualization layer in traditional methods, improves the virtual machine performance in terms of performance monitoring and optimization, and provides more accurate performance feedback for applications in the virtualization environment.

In some optional embodiments, before adding the target register information included in the target feature request to the pass-through list, the method further includes:
in response to determining that an instruction for detecting whether the host machine supports the target feature is received, acquiring and executing a processor feature detection instruction to obtain the feature information of the host machine; and
determining whether the host machine supports the target feature according to the feature information of the host machine.

Specifically, when receiving an instruction for detecting whether the host machine supports a specific hardware feature (i.e., the “target feature”), a series of operations are triggered to determine the actual capabilities of the host machine. Specifically, first, a “processor feature detection instruction” is acquired and executed. This instruction generally refers to the CPUID instruction, a standard x86 architecture instruction used to query detailed CPU information, including manufacturer, model, supported instruction sets, and feature flags. By executing the CPUID instruction, the feature information of the host machine can be obtained. Such information is presented in the form of a set of specific flags or return values, indicating which hardware features the host machine supports. Subsequently, the feature information is analyzed to check whether the feature information contains specific flags indicating support for the target feature. For example, if the target feature is the APERF/MPERF registers, the flags returned by CPUID are checked for corresponding APERF and MPERF support flags. If these flags exist, it indicates that the host machine supports the target feature; conversely, if these flags do not exist, it indicates that the host machine does not support the target feature. This process not only ensures that the virtualization environment can accurately identify the hardware capabilities of the host machine but also provides an important basis for subsequent feature enabling and virtual machine configuration, allowing the virtual machine to reasonably enable and utilize related features according to the actual hardware support of the host machine, thereby improving the performance and compatibility of the virtual machine.

In this way, by receiving the detection instruction and executing a processor feature detection instruction (such as CPUID), the solution can accurately obtain the feature information of the host machine and further determine whether the host machine supports the target feature (such as APERF/MPERF registers). This mechanism ensures that the virtualization environment can perform reasonable configuration and optimization according to the actual hardware capabilities of the host machine. Specifically, it enables the virtual machine to dynamically perceive the features of the host CPU and enable related features when supported, thereby improving the accuracy and real-time performance of performance monitoring. In addition, this detection mechanism enhances the flexibility and compatibility of the virtualization environment, allowing the virtual machine to adaptively adjust according to different hardware configurations of the host machine, ensuring optimal performance on various hardware platforms.

In some optional embodiments, before acquiring and executing the processor feature detection instruction to obtain the feature information of the host machine, the method further includes:
acquiring the processor feature detection instruction and adding the target
feature to the processor feature detection instruction; and executing the processor feature detection instruction to obtain the feature information of the host machine.

Specifically, the “processor feature detection instruction” generally refers to the CPUID instruction, a standard instruction in x86 architecture processors for obtaining detailed CPU information. By executing the CPUID instruction, information such as the CPU manufacturer, model, supported instruction sets, and various hardware features can be obtained. The “target feature” refers to specific hardware features or functions, such as APERF and MPERF registers, which are crucial for enabling the virtual machine to perceive dynamic frequency changes of the host CPU.

The implementation process of this solution includes the following: first, the CPUID instruction needs to be acquired, and the target feature to be queried is clearly specified in the instruction. This means that when executing the CPUID instruction, appropriate input parameters need to be set so that the instruction can return information related to the target feature. For example, to detect the support for APERF and MPERF registers, the input parameters of the CPUID instruction need to be set to return flags or function information related to these registers. Next, this modified CPUID instruction is executed to obtain the feature information of the host machine. Such information will clearly indicate whether the host CPU supports the target feature. If the host CPU supports these features, the corresponding flags or function information are set in the returned feature information, indicating that the host machine has these features. Conversely, if these flags are not set, it indicates that the host machine does not support the target feature. In this way, the solution can accurately detect whether the host machine supports specific hardware features, providing an important basis for subsequent virtualization operations.

In this way, by adding the target feature to the processor feature detection instruction (such as CPUID) and executing the instruction to obtain the feature information of the host machine, the solution can accurately detect whether the host machine supports specific hardware features. This mechanism ensures that the virtualization environment can perform reasonable configuration and optimization according to the actual hardware capabilities of the host machine, thereby improving the virtual machine ability to perceive the host CPU features. Specifically, the mechanism enables the virtual machine to dynamically perceive the features of the host CPU and enable related features when supported, thereby improving the accuracy and real-time performance of performance monitoring. In addition, this detection mechanism enhances the flexibility and compatibility of the virtualization environment, allowing the virtual machine to adaptively adjust according to different hardware configurations of the host machine, ensuring optimal performance on various hardware platforms.

In some optional embodiments, adding the target register information included in the target feature request instruction to the pass-through list if a request instruction for enabling a target feature is received includes:
in response to determining that an instruction for enabling the actual
performance frequency feature and the maximum performance frequency feature is received, adding the actual performance frequency register and the maximum performance frequency register to the pass-through list.

Specifically, the “instruction for enabling the actual performance frequency feature and the maximum performance frequency feature” refers to an instruction sent by virtualization management software (such as QEMU) to a kernel virtualization module (such as KVM) for enabling specific hardware features that allow the virtual machine to directly access the performance monitoring registers of the host CPU. Specifically, these features include the “actual performance frequency feature” (corresponding to the MSR_IA32_APERF register) and the “maximum performance frequency feature” (corresponding to the MSR_IA32_MPERF register). These registers respectively record the frequency of the CPU in the actual operating state and the frequency in the maximum performance state, which are crucial for real-time monitoring and optimization of CPU performance.

When KVM receives such an enabling request, it adds the identification information of these two registers to an internal list called the “pass-through list”. The pass-through list is a list maintained by KVM that records which hardware register values should be directly passed through to the virtual machine instead of being emulated or accessed indirectly through the virtualization layer. By adding the MSR_IA32_APERF and MSR_IA32_MPERF registers to the pass-through list, KVM ensures that the virtual machine can directly access the values of these registers, thereby obtaining the actual operating frequency and maximum performance frequency of the CPU in real time. This direct access method not only improves the accuracy and real-time performance of performance monitoring but also reduces the overhead of the virtualization layer, enabling the virtual machine to more efficiently utilize the performance monitoring features of the host CPU.

In this way, by receiving the request instruction for enabling the actual performance frequency feature and the maximum performance frequency feature and adding the corresponding registers to the pass-through list, the virtual machine can directly access these registers to obtain the actual operating frequency and maximum performance frequency of the CPU in real time. This mechanism significantly improves the virtual machine ability to perceive the host CPU performance, enhances the accuracy and real-time performance of performance monitoring, reduces the overhead of the virtualization layer, improves the performance of the virtual machine, and provides more accurate performance feedback for applications in the virtualization environment, facilitating more efficient and flexible resource management and performance optimization.

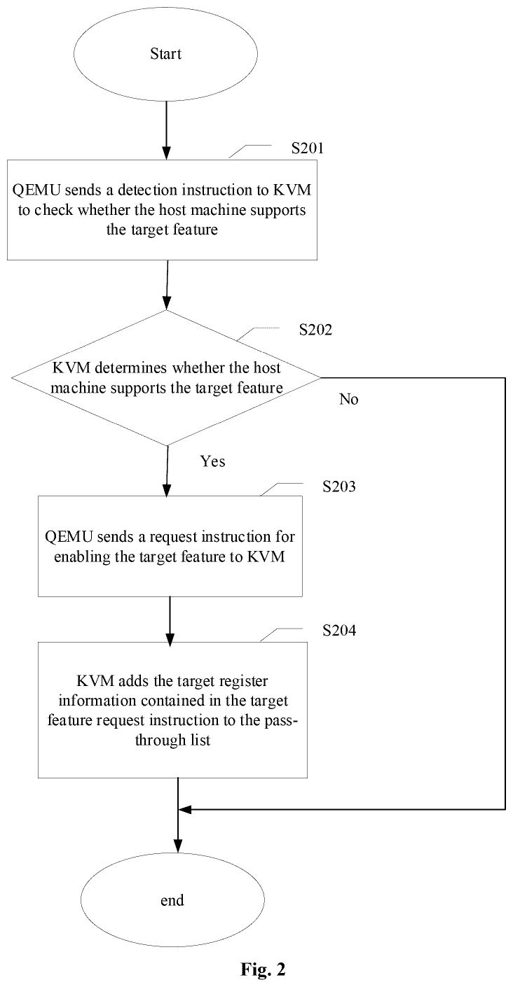

For an overall understanding of the pass-through mechanism of the present application, reference is made to FIG. 2, which is a schematic flow diagram corresponding to the pass-through mechanism in an embodiment of the present disclosure. The flow chart includes the following steps.

In step S201, QEMU sends a detection instruction to KVM to check whether the host machine supports the target feature.

In step S202, KVM determines whether the host machine supports the target feature.

In step S203, in response to determining that the host machine supports the target feature, QEMU sends a request instruction for enabling the target feature to KVM.

In step S204, KVM adds the target register information included in the target feature request instruction to the pass-through list, so that the virtual machine (VM) can obtain the register data of the target register during its operation.

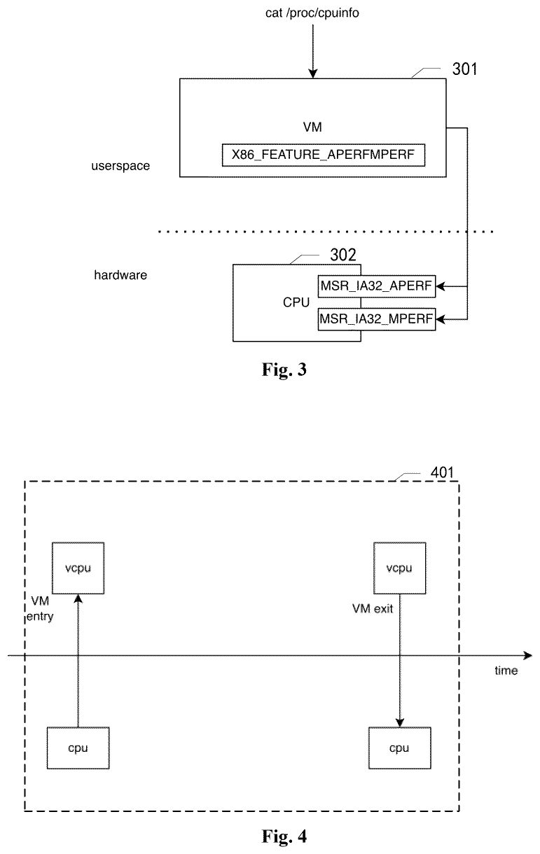

Reference is made to FIG. 3, which is a schematic diagram of the system corresponding to the pass-through mechanism in the embodiment of the present disclosure. The system includes a user space part 301 (userspace) and a hardware part 302 (hardware). The user space part 301 (userspace) refers to the operating environment of the virtual machine (VM), i.e., the space where the operating system and user applications are located; the hardware part 302 (hardware) refers to the physical hardware of the host machine, particularly the CPU, which specifically includes the MSR_IA32_APERF and MSR_IA32_MPERF registers.

The working principle corresponding to this figure is as follows: when the user executes “cat/proc/cpuinfo”, if the CPU supports the X86_FEATURE_APERFMPERF feature (i.e., the target feature), the virtual machine may directly obtain the values of MSR_IA32_MPERF and MSR_IA32_APERF. In this way, the virtual machine can accurately calculate its own operating frequency based on these real register data, thereby realizing real-time perception of dynamic frequency changes of the host CPU and improving the accuracy and real-time performance of performance monitoring.

In some optional embodiments, the method further includes:

when the virtual machine is migrated from the first physical processor of the host machine, a compensation value is calculated according to a register value of the actual performance frequency corresponding to the first physical processor and a register value of the maximum performance frequency corresponding to the first physical processor; the register value on the host machine side is compensated according to the compensation value; and the compensated register value is updated to the target register.

Specifically, the “first physical processor” refers to the host CPU core where the vCPU of the virtual machine is currently located. The “register value of the actual performance frequency” and “register value of the maximum performance frequency” refer to the values of the MSR_IA32_APERF and MSR_IA32_MPERF registers respectively. These two registers record the frequency of the CPU in the actual operating state and the frequency in the maximum performance state, respectively. When the vCPU of the virtual machine is migrated from the first physical processor of the host machine, the solution adopts a series of compensation measures to ensure that the virtual machine can accurately perceive the frequency changes of the host CPU.

In detail, KVM reads the values of the MSR_IA32_APERF and MSR_IA32_MPERF registers corresponding to the first physical processor, and calculates the frequency variation since the last update, i.e., the compensation value. Then, KVM adjusts the register value on the host machine side according to this compensation value to reflect the actual frequency changes during this period. Finally, KVM writes the compensated register value into the target register, ensuring that the virtual machine can continue to accurately monitor and optimize performance based on the latest frequency information after migration. This process not only ensures the continuity of the virtual machine perception of CPU frequency before and after migration but also improves the accuracy and stability of performance monitoring in the entire virtualization environment.

In this way, when the virtual machine is migrated from the first physical processor of the host machine, the compensation value is calculated using the values of the actual performance frequency register (MSR_IA32_APERF) and the maximum performance frequency register (MSR_IA32_MPERF); the register value on the host machine side is compensated based on this value; and the compensated value is then updated to the target register. This mechanism ensures that the virtual machine can accurately perceive the actual operating frequency of the host CPU before and after migration, thereby maintaining the continuity and accuracy of performance monitoring. This compensation mechanism not only solves the problem of inaccurate frequency perception caused by changes in physical processors during virtual machine migration but also improves the reliability and stability of performance monitoring in the virtualization environment, enabling the virtual machine to perform performance optimization and resource management more effectively.

In some optional embodiments, when a virtual machine is migrated from the first physical processor of the host machine, calculating a compensation value according to the register value of the actual performance frequency and the register value of the maximum performance frequency corresponding to the first physical processor, compensating the register value on the host side according to the compensation value, and updating the compensated register value to the target register includes:
when the virtual machine exits from the first physical processor, obtaining the register value of the actual performance frequency and the register value of the maximum performance frequency corresponding to the first physical processor, respectively thereby obtaining a first register value of the actual performance frequency and a first register value of the maximum performance frequency;
calculating a compensation value according to the first register value of the actual performance frequency and the first register value of the maximum performance frequency;
compensating the first register value of the actual performance frequency and the first register value of the maximum performance frequency according to the compensation value to obtain a second register value of the actual performance frequency and a second register value of the maximum performance frequency;
storing the second register value of the actual performance frequency and the second register value of the maximum performance frequency in the actual performance frequency register and the maximum performance frequency register respectively.

Specifically, this solution proposes a processing mechanism for when a virtual machine exits from the first physical processor, aiming at the performance monitoring problem of virtual machines in virtualized environments. Specifically, when the vCPU of the virtual machine exits from the first physical processor, the values of the actual performance frequency register (MSR_IA32_APERF) and the maximum performance frequency register (MSR_IA32_MPERF) corresponding to the processor are obtained, which are respectively recorded as the first register value of the actual performance frequency and the first register value of the maximum performance frequency. These two registers respectively record the frequency of the CPU in the actual operating state and the frequency in the maximum performance state, which are crucial for real-time monitoring of CPU performance.

Next, a compensation value is calculated based on these two register values. The calculation of the compensation value is to adjust the frequency perception difference caused by virtual machine migration or scheduling, ensuring that the virtual machine can accurately perceive the actual operating frequency of the host CPU before and after migration. By applying the compensation value to the first register value of the actual performance frequency and the first register value of the maximum performance frequency, the second register value of the actual performance frequency and second register value of the maximum performance frequency are obtained by the updating.

Finally, these two updated register values are stored back into the actual performance frequency register and the maximum performance frequency register respectively. This process not only ensures the continuity and accuracy of the virtual machine perception of CPU frequency before and after migration but also improves the stability and reliability of performance monitoring in the entire virtualized environment. Through this mechanism, virtual machines can perform performance optimization and resource management more effectively, thereby improving the overall performance of the virtualized environment.

In this way, by obtaining and calculating the compensation value when the virtual machine exits from the first physical processor, then compensating and updating the register values, it is ensured that the virtual machine can accurately perceive the actual operating frequency of the host CPU before and after migration. This mechanism not only solves the problem of inaccurate frequency perception caused by changes in physical processors during virtual machine migration but also improves the continuity and stability of performance monitoring in the virtualized environment. Through this compensation mechanism, virtual machines can perform performance optimization and resource management more effectively, thereby enhancing the overall performance of the virtualized environment.

In some optional embodiments, calculating the compensation value according to the first register value of the actual performance frequency and the first register value of the maximum performance frequency includes:
obtaining the most recently updated register value of the actual performance frequency and the most recently updated register value of the maximum performance frequency;
calculating a difference between the first register value of the actual performance frequency and the most recently updated register value of the actual performance frequency to obtain a compensation value of the actual performance frequency register;
calculating a difference between the first register value of the maximum performance frequency and the most recently updated register value of the maximum performance frequency to obtain a compensation value of the maximum performance frequency register.

Specifically, this solution introduces a compensation mechanism to ensure that the virtual machine can accurately perceive the actual operating frequency of the host CPU before and after migration. Specifically, first, the most recently updated register value of the actual performance frequency (MSR_IA32_APERF) and most recently updated register value of the maximum performance frequency (MSR_IA32_MPERF) are obtained. These values respectively record the frequency of the CPU in the actual operating state and the frequency in the maximum performance state, which are important bases for virtual machine performance monitoring.

Next, the difference between the first register value of the actual performance frequency at the current moment and the most recently updated register value of the actual performance frequency is calculated to obtain the compensation value of the actual performance frequency register. Similarly, the difference between the first register value of the maximum performance frequency at the current moment and the most recently updated register value of the maximum performance frequency is calculated to obtain the compensation value of the maximum performance frequency register.

In this way, this solution can accurately calculate the amount of change in CPU frequency between two moments. These compensation values reflect the frequency changes of the CPU in actual operation and maximum performance states, which are crucial for maintaining the continuity and accuracy of performance monitoring when the virtual machine is migrated or scheduled. By applying these compensation values, the virtual machine can more accurately perceive the actual operating frequency of the host CPU, thereby improving the reliability of performance monitoring, optimizing resource management, and enhancing the overall performance of the virtualized environment.

In this way, by obtaining the most recently updated register value of the actual performance frequency and the most recently updated register value of the maximum performance frequency, and calculating the differences between the current values and the most recently updated values to obtain the compensation values, this solution can accurately quantify the change in CPU frequency. This mechanism enables the virtual machine to use these compensation values to adjust its performance monitoring data during migration or scheduling, ensuring that the virtual machine perception of CPU frequency remains continuous and accurate when migrating between different physical processors. This not only improves the reliability of performance monitoring but also optimizes resource management, enhances the overall performance of the virtualized environment, and ensures that the virtual machine can perform effective performance optimization based on the latest frequency information.

In some optional embodiments, compensating the first register value of the actual performance frequency and the first register value of the maximum performance frequency according to the compensation value to obtain a second register value of the actual performance frequency and a second register value of the maximum performance frequency includes:
accumulating the first register value of the actual performance frequency and the compensation value of the actual performance frequency register, and taking the accumulated result as the second register value of the actual performance frequency;
accumulating the first register value of the maximum performance frequency and the compensation value of the maximum performance frequency register, and taking the accumulated result as the second register value of the maximum performance frequency.

Specifically, the “first register value of the actual performance frequency” and “first register value of the maximum performance frequency” in this solution refer to the values of the actual performance frequency (MSR_IA32_APERF) and maximum performance frequency (MSR_IA32_MPERF) registers obtained from the current physical processor before the virtual machine migration. These registers respectively record the frequency of the CPU in the actual operating state and the frequency in the maximum performance state. The “compensation value of the actual performance frequency register” and “compensation value of the maximum performance frequency register” are obtained by calculating the difference between the current value and the most recently updated value, which are used to compensate for the frequency perception difference caused by virtual machine migration or scheduling.

The implementation process of the solution includes accumulating the first register value of the actual performance frequency and the compensation value of the actual performance frequency register, and taking the result as the second register value of the actual performance frequency. Similarly, the first register value of the maximum performance frequency and the compensation value of the maximum performance frequency register are accumulated, and the accumulated result is taken as the second register value of the maximum performance frequency. Through this accumulation operation, the frequency information before migration can be combined with the compensation value to obtain a more accurate frequency value that reflects the actual operating state of the virtual machine after migration. This process not only ensures the continuity of the virtual machine perception of CPU frequency before and after migration but also improves the accuracy and stability of performance monitoring, enabling the virtual machine to perform effective performance optimization and resource management based on the latest frequency information.

In this way, by accumulating the first register value of the actual performance frequency with the compensation value of the actual performance frequency register, and the first register value of the maximum performance frequency with the compensation value of the maximum performance frequency register, this solution can generate more accurate second register value of the actual performance frequency and second register value of the maximum performance frequency. This accumulation operation ensures that the virtual machine can continuously and accurately perceive the actual operating frequency and maximum performance frequency of the host CPU before and after migration. This mechanism significantly improves the virtual machine ability to perceive changes in the host CPU frequency, enhances the accuracy and stability of performance monitoring, thereby providing more reliable performance feedback for applications in the virtualized environment and facilitating more efficient and flexible resource management and performance optimization.

To facilitate an overall understanding of the compensation mechanism of the present application, reference is first made to FIG. 4, which is a schematic diagram of the process of reading and writing register data in an embodiment of the present disclosure. Taking the host processor 401 (also referred to as CPU) as an example, when the vCPU starts running on the host processor 401 (i.e., VM entry), it is necessary to read the register value corresponding to the current CPU; when the vCPU stops running on the host processor 401 (i.e., VM exit), the updated value is written into the register of the current CPU so that the latest performance data can be reflected during the next access.

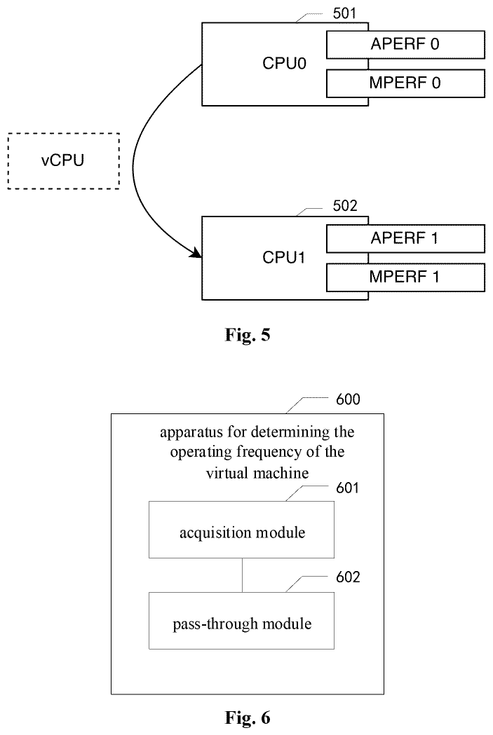

Referring to FIG. 5, which is a schematic diagram of the process corresponding to the compensation mechanism in an embodiment of the present disclosure, that is, the figure shows the process of updating register data when the vCPU exits from a physical processor. Take the virtual machine (vCPU) exiting from CPU0 (also referred to as the first physical processor 501) and then entering CPU1 (referred to as the second physical processor 502) as an example, that is, the process of updating the register value when the vCPU migrates from CPU0 to CPU1. The registers corresponding to CPU0 are APERF0 and MPERF0, and the registers corresponding to CPU1 are APERF1 and MPERF1. When the vCPU migrates from CPU0 to CPU1, the vCPU first triggers a VM exit (virtual machine exit event) from CPU0 to exit execution, then migrates the vCPU to CPU1, and triggers a VM entry (virtual machine entry event) on CPU1 to run in CPU1. When the vCPU triggers a VM exit from CPU0, KVM reads the current APERF0 and MPERF0 values of CPU0 and calculates the increment during this period (also referred to as the compensation value), where the compensation value satisfies the following formulas:

^{Δ}aperf=APERF0−v_aperf; where ^{Δ}aperf is the compensation value of

the actual performance frequency register, APERF0 is the first register value of the actual performance frequency, and v_aperf is the most recently updated register value of the actual performance frequency;

^{Δ}mperf=MPERF0−v_mperf; where ^{Δ}mperf is the compensation value

of the maximum performance frequency register, MPERF0 is the first register value of the maximum performance frequency, and v_mperf is the most recently updated register value of the maximum performance frequency.

After calculating the compensation values, the compensations are respectively applied to aperf (first register value of the actual performance frequency) and mperf (first register value of the maximum performance frequency), and the compensated aperf and mperf are written back to the APERF0 and MPERF0 registers of CPU0 through the write model-specific register instruction. At the same time, APERF0 is saved as the value of v_aperf, and MPERF0 is saved as the value of v_mperf, so that the value of the vCPU can be obtained for next use.

When the vCPU triggers a VM entry on CPU1 to run in CPU1, KVM reads the current APERF1 and MPERF1 values of CPU1 and assigns them to aperf and mperf. At the same time, the v_aperf and v_mperf on the virtual machine side are written into the MSR registers.

The following describes the device embodiment of the present application, which may be used to execute the method for determining an operating frequency of a virtual machine in the above embodiment of the present application. For details not disclosed in the device embodiment of the present application, please refer to the embodiment of the method for determining the operating frequency of a virtual machine of the present application.

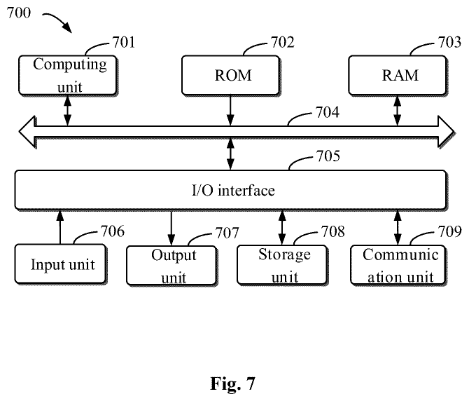

The present disclosure further provides an apparatus 600 for determining the operating frequency of the virtual machine, as shown in FIG. 6, including:
acquisition module 601, configured to obtain a target register from a pass-through list and acquire register data corresponding to the target register, where the registers in the pass-through list are accessible by a virtual machine; and
pass-through module 602, configured to, during the operation of the virtual machine, in response to receiving an instruction to read target register data, pass through the register data corresponding to the target register to the virtual machine, so that the virtual machine obtains the operating frequency of the virtual machine according to the register data.

In some optional embodiments, before obtaining the target register from the pass-through list, the acquisition module 601 is further configured to, in response to determining that receiving a request instruction of enabling a target feature, add target register information included in the request instruction of enabling the target feature to the pass-through list.

In some optional embodiments, before adding the target register information included in the request instruction of enabling the target feature to the pass-through list, the acquisition module 601 is further configured to:
in response to receiving a detection instruction for detecting whether the host machine supports the target feature, acquire a processor feature detection instruction and execute the instruction to obtain feature information of the host machine; and
determine whether the host machine supports the target feature according to the feature information of the host machine.

In some optional embodiments, before acquiring the processor feature detection instruction and executing the instruction to obtain the feature information of the host machine, the acquisition module 601 is further configured to:
acquire the processor feature detection instruction and add the target feature to the processor feature detection instruction;
execute the processor feature detection instruction to obtain the feature information of the host machine.

In some optional embodiments, the acquisition module 601, is configured to:
in response to receiving a request instruction of enabling the actual
performance frequency feature and the maximum performance frequency feature, add an actual performance frequency register and a maximum performance frequency register to the pass-through list.

In some optional embodiments, the apparatus further includes a migration module configured to:
when the virtual machine is migrated from the first physical processor of the host machine, calculate a compensation value according to an actual performance frequency register value and a maximum performance frequency register value corresponding to the first physical processor, compensate the register value on the host machine side according to the compensation value, and update the compensated register value to the target register.

In some optional embodiments, the migration module is configured to:
when the virtual machine exits from the first physical processor, acquire a register value of the actual performance frequency and a register value of the maximum performance frequency corresponding to the first physical processor respectively, and obtain a first register value of the actual performance frequency and a first register value of the maximum performance frequency;
calculate a compensation value according to the first register value of the actual performance frequency and the first register value of the maximum performance frequency;
compensate the first register value of the actual performance frequency and the first register value of the maximum performance frequency according to the compensation value to obtain a second register value of the actual performance frequency and a second register value of the maximum performance frequency;
store the second register value of the actual performance frequency and the second register value of the maximum performance frequency into the actual performance frequency register and the maximum performance frequency register, respectively.

In some optional embodiments, the migration module is configured to:
acquire a most recently updated register value of the actual performance frequency and a most recently updated register value of the maximum performance frequency;
calculate a difference between the first register value of the actual performance frequency and the most recently updated register value of the actual performance frequency to obtain a compensation value of the actual performance frequency register;
calculate a difference between the first register value of the maximum performance frequency and the most recently updated register value of the maximum performance frequency to obtain a compensation value of the maximum performance frequency register.

In some optional embodiments, the migration module is configured to:
accumulate the first register value of the actual performance frequency and the compensation value of the actual performance frequency register, and use the accumulated result as the second register value of the actual performance frequency;
accumulate the first register value of the maximum performance frequency and the compensation value of the maximum performance frequency register, and use the accumulated result as the second register value of the maximum performance frequency.

In the technical solution of the present disclosure, the acquisition, storage, and application of user personal information all comply with relevant laws and regulations and do not violate public order and good morals.

According to the embodiments of the present disclosure, the present disclosure further provides an electronic device, a readable storage medium, and a computer program product.

FIG. 7 shows a schematic block diagram of an example electronic device 700 that may be used to implement embodiments of the present disclosure. Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 7, the electronic device 700 includes a computing unit 701, which may perform various appropriate actions and processes according to a computer program stored in a read-only memory (ROM) 702 or a computer program loaded into a random access memory (RAM) 703 from a storage unit 708. In RAM 703, various programs and data required for operation of the device 700 may also be stored. The computing unit 701, ROM 702 and RAM 703 are connected to each other via a bus 704. An input/output (I/O) interface 705 is also connected to bus 704.

A plurality of components in the device 700 are connected to the I/O interface 705, including an input unit 706, such as a keyboard, a mouse, and the like; an output unit 707, for example, various types of displays, speakers, and the like; a storage unit 708, such as a magnetic disk, an optical disk, or the like; and a communication unit 709, such as a network card, a modem, or a wireless communication transceiver. The communication unit 709 allows the device 700 to exchange information/data with other devices over a computer network such as the Internet and/or various telecommunications networks.

The computing unit 701 may be various general-purpose and/or special-purpose processing components having processing and computing capabilities. Some examples of computing units 701 include, but are not limited to, central processing units (CPUs), graphics processing units (GPUs), various specialized artificial intelligence (AI) computing chips, various computing units running machine learning model algorithms, digital signal processors (DSPs), and any suitable processors, controllers, microcontrollers, and the like. The computing unit 701 performs various methods and processes described above, such as a method for determining the operating frequency of the virtual machine. For example, in some embodiments, a method of determining the operating frequency of the virtual machine may be implemented as a computer software program tangibly embodied in a machine-readable medium, such as a storage unit 708. In some embodiments, some or all of the computer program may be loaded and/or installed on the device 700 via the ROM 702 and/or the communication unit 709. When the computer program is loaded to the RAM 703 and executed by the computing unit 701, one or more steps of the method described above may be performed. Alternatively, in other embodiments, the computing unit 701 may be configured to perform a method of determining the operating frequency of the virtual machine by any other suitable means (e.g., by means of firmware).

The various embodiments of the systems and techniques described above herein may be implemented in digital electronic circuit systems, integrated circuit systems, field programmable gate arrays (FPGAs), application specific integrated circuits (ASICs), application specific standard products (ASSP), systems on a system on a chip (SOC), load programmable logic devices (CPLDs), computer hardware, firmware, software, and/or combinations thereof. These various embodiments may include being implemented in one or more computer programs that may execute and/or interpret on a programmable system including at least one programmable processor, which may be a dedicated or general purpose programmable processor, may receive data and instructions from a memory system, at least one input device, and at least one output device, and transmit the data and instructions to the memory system, the at least one input device, and the at least one output device.

The program code for carrying out the methods of the present disclosure may be written in any combination of one or more programming languages. These program codes may be provided to a processor or controller of a determining device for the frequency of operation of a general purpose computer, special purpose computer, or other programmable virtual machine such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include one or more line-based electrical connections, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the foregoing.

To provide interaction with a user, the systems and techniques described herein may be implemented on a computer having a display device (e.g., a CRT (cathode ray tube) or LCD (liquid crystal display) monitor) for displaying information to the user; And a keyboard and a pointing device (e.g., a mouse or a trackball) through which a user can provide input to a computer. Other types of devices may also be used to provide interaction with a user; for example, the feedback provided to the user may be any form of sensory feedback (e.g., visual feedback, auditory feedback, or tactile feedback); And input from the user may be received in any form, including acoustic input, speech input, or tactile input.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

The computer system may include a client and a server. The client and server are typically remote from each other and typically interact through a communication network. The relationship between the client and the server is generated by a computer program running on the corresponding computer and having a client-server relationship with each other. The server may be a cloud server, a server of a distributed system, or a server incorporating a chain of blocks.

It is to be understood that the steps of reordering, adding or deleting may be performed using the various forms shown above. For example, the steps described in the present disclosure may be performed in parallel or sequentially, and may be performed in a different order, so long as the desired results of the technical solution of the present disclosure can be realized, and are not limited herein.

The foregoing detailed description is not intended to limit the scope of the present disclosure. It will be appreciated by those skilled in the art that various modifications, combinations, subcombinations, and substitutions may be made depending on design requirements and other factors. Any modifications, equivalents, and modifications that fall within the spirit and principles of the disclosure are intended to be included within the scope of protection of the disclosure.

What is claimed is:

1. A method for determining an operating frequency of a virtual machine, the method comprising:
acquiring a target register from a pass-through list, and acquiring register data corresponding to the target register, wherein registers in the pass-through list are accessible by the virtual machine; and
passing through register data corresponding to the target register to the virtual machine during operation of the virtual machine, in response to receiving an instruction of reading the target register data, such that the virtual machine obtains the operating frequency of the virtual machine according to the register data.

2. The method according to claim 1, wherein the method further comprises:
adding target register information included in a request instruction for enabling a target feature to the pass-through list, in response to determining that the request instruction for enabling the target feature is received.

3. The method according to claim 2, wherein the method further comprises:
in response to determining that a detection instruction for detecting whether a host machine supports the target feature is received, acquiring a processor feature detection instruction and executing the instruction to obtain feature information of the host machine; and
determining whether the host machine supports the target feature based on the feature information of the host machine.

4. The method according to claim 3, wherein the method further comprises:
obtaining the processor feature detection instruction and adding the target feature to the processor feature detection instruction; and
executing the processor feature detection instruction to obtain feature information of the host machine.

5. The method according to claim 2, wherein the adding the target register information included in the request instruction of enabling the target feature to the pass-through list in response to determining that the request instruction of enabling a target feature is received comprises:
in response to determining that a request for enabling an actual performance frequency feature and a maximum performance frequency feature is received, adding an actual performance frequency register and a maximum performance frequency register to the pass-through list.

6. The method according to claim 1, wherein the method further comprises:
when the virtual machine migrates from a first physical processor of the host machine, calculating a compensation value according to a register value of the actual performance frequency and a register value of the maximum performance frequency corresponding to the first physical processor, compensating a register value on a host side according to the compensation value, and updating the compensated register value to the target register.

7. The method according to claim 6, wherein when the virtual machine migrates from the first physical processor of the host machine, calculating a compensation value according to the register value of the actual performance frequency and the register value of the maximum performance frequency corresponding to the first physical processor, compensating the register value on the host machine side according to the compensation value, and updating the compensated register value to the target register comprises:
when the virtual machine exits from the first physical processor, acquiring a register value of the actual performance frequency and a register value of the maximum performance frequency corresponding to the first physical processor, as a first register value of the actual performance frequency and a first register value of the maximum performance frequency respectively;
calculating a compensation value based on the first register value of the actual performance frequency and the first register value of the maximum performance frequency;
compensating the first register value of the actual performance frequency and the first register value of the maximum performance frequency according to the compensation value to obtain a second register value of the actual performance frequency and a second register value of the maximum performance frequency; and
storing the second register value of the actual performance frequency and the second register value of the maximum performance frequency into the actual performance frequency register and the maximum performance frequency register respectively.

8. The method according to claim 7, wherein the calculating the compensation value based on the first register value of the actual performance frequency and the first register value of the maximum performance frequency comprises:
obtaining a most recently updated register value of the actual performance frequency and a most recently updated register value of the maximum performance;
calculating a difference between the first register value of the actual performance frequency and the most recently updated register value of the actual performance frequency to obtain a compensation value of the actual performance frequency register; and
calculating a difference between the first register value of the maximum performance frequency and the most recently updated register value of the maximum performance frequency to obtain a compensation value of the maximum performance frequency register.

9. The method according to claim 8, wherein compensating the first register value of the actual performance frequency and the first register value of the maximum performance frequency according to the compensation value to obtain the second register value of the actual performance frequency and the second register value of the maximum performance frequency comprises:
accumulating the first register value of the actual performance frequency and the compensation value of the actual performance frequency register, and taking an accumulation result as the second register value of the actual performance frequency; and
accumulating the first register value of the maximum performance frequency and the compensation value of the maximum performance frequency register, and taking an accumulating result as the second register value of the maximum performance frequency.

10. An electronic device, comprising:
at least one processor; and
a memory in communication with the at least one processor;
wherein the memory stores instructions executable by the at least one processor to enable the at least one processor to perform operations comprising:
acquiring a target register from a pass-through list, and acquiring register data corresponding to the target register, wherein registers in the pass-through list are accessible by the virtual machine; and
passing through register data corresponding to the target register to the virtual machine during operation of the virtual machine, in response to receiving an instruction of reading the target register data, so that the virtual machine obtains the operating frequency of the virtual machine according to the register data.

11. The electronic device according to claim 10, wherein the operations further comprise:
adding target register information included in a request instruction for enabling a target feature to the pass-through list, in response to determining that the request instruction for enabling the target feature is received.

12. The electronic device according to claim 11, wherein the operations further comprise:
in response to determining that a detection instruction for detecting whether a host machine supports the target feature is received, acquiring a processor feature detection instruction and executing the instruction to obtain feature information of the host machine; and
determining whether the host machine supports the target feature based on the feature information of the host machine.

13. The electronic device according to claim 12, wherein the operations further comprise:
obtaining the processor feature detection instruction and adding the target feature to the processor feature detection instruction; and
executing the processor feature detection instruction to obtain feature information of the host machine.

14. The electronic device according to claim 11, wherein the adding the target register information included in the request instruction of enabling the target feature to the pass-through list in response to determining that the request instruction of enabling a target feature is received comprises:
in response to determining that a request for enabling an actual performance frequency feature and a maximum performance frequency feature is received, adding an actual performance frequency register and a maximum performance frequency register to the pass-through list.

15. The electronic device according to claim 10, wherein the operations further comprise:
when the virtual machine migrates from a first physical processor of the host machine, calculating a compensation value according to a register value of the actual performance frequency and a register value of the maximum performance frequency corresponding to the first physical processor, compensating a register value on a host side according to the compensation value, and updating the compensated register value to the target register.

16. The electronic device according to claim 15, wherein when the virtual machine migrates from the first physical processor of the host machine, calculating a compensation value according to the register value of the actual performance frequency and the register value of the maximum performance frequency corresponding to the first physical processor, compensating the register value on the host machine side according to the compensation value, and updating the compensated register value to the target register comprises:
when the virtual machine exits from the first physical processor, acquiring a register value of the actual performance frequency and a register value of the maximum performance frequency corresponding to the first physical processor, as a first register value of the actual performance frequency and a first register value of the maximum performance frequency respectively;
calculating a compensation value based on the first register value of the actual performance frequency and the first register value of the maximum performance frequency;
compensating the first register value of the actual performance frequency and the first register value of the maximum performance frequency according to the compensation value to obtain a second register value of the actual performance frequency and a second register value of the maximum performance frequency; and
storing the second register value of the actual performance frequency and the second register value of the maximum performance frequency into the actual performance frequency register and the maximum performance frequency register respectively.

17. The electronic device according to claim 16, wherein the calculating the compensation value based on the first register value of the actual performance frequency and the first register value of the maximum performance frequency comprises:
obtaining a most recently updated register value of the actual performance frequency and a most recently updated register value of the maximum performance;
calculating a difference between the first register value of the actual performance frequency and the most recently updated register value of the actual performance frequency to obtain a compensation value of the actual performance frequency register; and
calculating a difference between the first register value of the maximum performance frequency and the most recently updated register value of the maximum performance frequency to obtain a compensation value of the maximum performance frequency register.

18. The electronic device according to claim 17, wherein compensating the first register value of the actual performance frequency and the first register value of the maximum performance frequency according to the compensation value to obtain the second register value of the actual performance frequency and the second register value of the maximum performance frequency comprises:
accumulating the first register value of the actual performance frequency and the compensation value of the actual performance frequency register, and taking an accumulation result as the second register value of the actual performance frequency; and
accumulating the first register value of the maximum performance frequency and the compensation value of the maximum performance frequency register, and taking an accumulating result as the second register value of the maximum performance frequency.

19. A non-transitory computer-readable storage medium storing computer instructions for causing the computer to perform operations, comprising:
acquiring a target register from a pass-through list, and acquiring register data corresponding to the target register, wherein registers in the pass-through list are accessible by the virtual machine; and
passing through register data corresponding to the target register to the virtual machine during operation of the virtual machine, in response to receiving an instruction of reading the target register data, so that the virtual machine obtains the operating frequency of the virtual machine according to the register data.
